(19) United States
(12) Patent Application Publication
(10) Pub. No.: US 2017/0091638 A1
(43) Pub. Date: Mar. 30, 2017

(54) APPARATUS AND METHODS FOR NONDETERMINISTIC COMPUTING

(71) Applicant: Aizhong Li, Ottawa (CA)

(72) Inventor: Aizhong Li, Ottawa (CA)

(73) Assignee: Aizhong Li, Ottawa (CA)

(21) Appl. No.: 14/866,995

(22) Filed: Sep. 27, 2015

(51) Int. Cl. G06N 7/00

(52) U.S. Cl. CPC G06N 7/00

(57) ABSTRACT

In the disclosed nondeterministic computing apparatus and methods, a user problem to be solved is represented as a nondeterministic Turing machine M with an input X to it. A method for deterministic simulation of M on X is disclosed, which performs assumptions and refutations. The disclosed method is the first deterministic method with polynomial time complexity in the worst case if the time complexity of M is of polynomial time complexity, where time complexity is measured as a function of the length of X.

### TECHNICAL FIELD

The present invention relates to a nondeterministic computing apparatus, or more specifically relates to a method of simulating nondeterministic computation using a deterministic computing apparatus efficiently.

### BACKGROUND ART

As known in the prior art, in general, there are two kinds of computing apparatus: deterministic and nondeterministic. A deterministic computing apparatus, such as an electronic computer, is modeled mathematically by a deterministic Turing machine (DTM), which has a single sequence of primitive operations for a given input. A nondeterministic computing apparatus is modeled mathematically by a nondeterministic Turing machine (NDTM), which may have multiple ‘simultaneous’ or ‘parallel’ sequences of primitive operations for a given input. DTM is a degeneration of NDTM. There are various NP-complete problems in practice, such as the satisfiability problem, the traveling salesman problem, and the integer linear programming problem, which can be solved in polynomial time by a NDTM. If one of them is solved by a DTM in polynomial time, then all of them can be solved by a DTM in polynomial time. Currently there are two approaches to a nondeterministic computing apparatus:
1. A probabilistic or physically nondeterministic computing apparatus to improve the performance at the loss of correctness. For example:
   U.S. Pat. No. 6,463,422: “Probabilistic computing methods and apparatus”;
   U.S. Pat. No. 7,400,282: “Quantum turing machine”;
   U.S. Pat. No. 7,130,093: “Optical implementation of bounded nondeterministic Turing Machines”;
   U.S. Pat. No. 5,843,661: “Method for Construction Universal DNA based Molecular Turing Machine”;
   U.S. Pat. No. 6,266,569: “Method and System of Computing Similar to a Turing Machine”;
2. A simulated nondeterministic computing apparatus by use of a deterministic apparatus to improve the performance of some specific problems on some specific inputs in terms of heuristics. But the time complexity is exponential in general. For example:
   U.S. Pat. No. 7,577,625: “Handling of Satisfaction and Conflicts in a Quantified Boolean Formula Solver”;
   U.S. Pat. No. 7,992,113: “Methods and Apparatus for Decision Making in Resolution based SAT-solvers”; and
   U.S. Pat. No. 7,860,814: “System and Method for Providing a User-selected Best Solution to an NP-complete Scheduling Problem”.
   U.S. Pat. No. 5,678,055: “Method and Device for Generating Grobner Bases to Reduce Memory Usage and Increase Computing Speed”.
   Wen-Tsun Wu's specific method is more efficient in practice in elementary geometry than Buchberger's general method, where polynomial equations are arranged into row echelon (or triangular) form, with reference made to Cox, D., J. Little and D. O'shea [2007]: IDEAS, VARIETIES, AND ALGORITHMS—An Introduction to Computational Algebraic Geometry and Commutative Algebra, Springer.
   U.S. Pat. No. 8,577,825 B2: “System, Method and Device for Solving Problems in NP without Hyper-polynomial Cost”.
      In summary, “None of us truly understand the P versus NP problem, we have only begun to peel the layers around this increasingly complex question. Perhaps we will see a resolution of the P versus NP problem in the near future but I almost hope not. The P versus NP problem continues to inspire and boggle the mind and continued exploration of this problem will lead us to yet even new complexities in that truly mysterious process we call computation.” quoted from Fortnow, L. [2009]: “The Status of The P versus NP Problem”, Communications of the ACM, Vol. 52, No. 9, 78-86.

### DISCLOSURE OF INVENTION

### The Technical Problem

The purpose of the invention is to provide an efficient realization of nondeterministic computations to solve practical problems. With reference made to Aho, A. V., J. E. Hopcroft and J. D. Ullman [1974]: The Design and Analysis of Computer Algorithms, Addison-Wesley; without limiting, throughout the present invention, a single-tape nondeterministic Turing machine (NDTM) with an input is adopted as the representation of a user's problem, where the NDTM is denoted by 7-tuple M:=(Q, Y, Σ, δ, b, q₀, Q_{f}), where
Q is the finite set of states, each of which may encode the state of a physical object;
Y is the finite set of tape symbols, each of which may encode a physical object;
Σ, a proper subset of Y, is the set of input symbols, each of which may encode a physical object;
b, in Y-Σ, is the blank symbol, which may encode a special placeholder or delimiter;
q₀, in Q, is the initial state;
Q_{f}, a subset of Q, is the set of final states;
δ, a subset of (Q−Q_{f})×Y×Q×Y×D, is the transition relation, where D={−1, +1} for direction left and right, respectively. If ∀_{p∈Q-Q}_{_{f}}_{,x∈Y}|{(q, y, d)/(p, x, q, y, d)∈δ}|≦1, M is a deterministic Turing machine (DTM). δ may encode the operations and/or relationships of physical objects.

In one exemplary embodiment of the invention, using Java as the programming language, M is stored as a Java class encapsulates the following instances:
1. Q as a TreeSet<State> instance, where class State encapsulates a string;
2. Y as a TreeSet<Symbol> instance, where class Symbol encapsulates a string;
3. I as another TreeSet<Symbol> instance;
4. b as the null;
5. q₀ as a State instance;
6. Q_{f} as another TreeSet<State> instance;
7. δ as a Hashtable<Condition, <TreeSet<Action>>> instance, where
   Class Condition encapsulates a State instance and a Symbol instance;
   Class Action is encapsulates a State instance, a Symbol instance state, and a Byte instance with values −1 and +1 for direction left and right, respectively.
      Summarily, an input X to the M is represented as an array of Symbol. Therefore both M and X are stored in a computer readable format as a user's problem. The invention includes optional transformation of user's problems in other format into the above-specified format or transform the disclosed method to process the user's problem directly.

The problem of the invention is to decide whether M accepts X. The problem can be restated as whether a physical object in its initial state can be transformed into another physical object (including the same object) in a final state by a sequence of primitive physical operations. If the input is accepted, the problem may further include finding one or more operation sequences leading the initial state to a final state at user's preference, especially in planning and scheduling.

### Technical Solution to the Problem

The invention provides a method to solve the problem of the present invention.

First, the method defines and utilizes a relational model to represent the multiple nondeterministic computations of M on X as follows.

Let the time complexity of M be T(n) for an input X of length n. The range of steps T:=[0, T(n)]. The range of tape head positions H:=[−T(n), T(n)]. Please note := may be read as “is/are/being assigned to” depending on its context.

Let the input X:=X₀ . . . Xₙ₋₁, in Σ*, of length n, be padded with blanks, i.e. Xᵢ=b for T(n)≧i≧n or −T(n)≦i<0 for easy treatment only.

For an event e to be defined later in T×H×Q×Y×D, its components are denoted by e·t, e·h, e·q, e·y, and e·d, respectively. Similarly, for a trievent m to be defined later in W×P×C, its components are denoted by m·w, m·p, and m·c, respectively; where W:=P:=C:=T×H×Q×Y×D. A null is a placeholder for the absence of an event.

For M on input X, t-computations C(t) (i.e. a deterministic computation path of t+1 events including the initial event) and relation R(t) (i.e. valid trievents in W×P×C) are defined simultaneously by recursion on step t as follows.

C(0):={e₀} and R(0):={(null,null,e₀)}, where the initial event e₀:=(0,−1,q₀,b,+1) in T×H×Q×Y×D.

C(t+1):=φ and R(t+1):=φ;
For e₀# . . . #eₜ∈C(t) and for event eₜ₊₁∈T×H×Q×Y×D with eₜ₊₁·t=t+1 and eₜ₊₁·h=eₜ·h+eₜ·d, (Note that delimiter # is used for a sequence of events to avoid ambiguity)
   If there exists 0≦i≦t such that eᵢ·h=eₜ₊₁·h, then let k be the maximum of such i's;

If (eₜ·q,eₖ·y,eₜ₊₁·q,eₜ₊₁·y,eₜ₊₁·d)∈δ, then

C(t+1):=C(t+1)∪{e₀# . . . #eₜ#eₜ₊₁}, and

R(t+1):=R(t+1)∪{(eₖ,eₜ,eₜ₊₁)};

Otherwise,

If(eₜ·q,Xₑ_{ₜ₊₁}_{·h},eₜ₊₁·q,eₜ₊₁·y,eₜ₊₁·d)∈δ,then

C(t+1):=C(t+1)∪{e₀# . . . #eₜ#eₜ₊₁}, and

R(t+1):=R(t+1)∪{(null,eₜ,eₜ₊₁)}.

Second, define some exemplary common operations with intended semantics in the relational model to be used in the disclosed methods.

For an arbitrary subset S of R(0)∪ . . . ∪R(t) and an event e, to assume event e exclusively at step e·t in t-computations in S, define

A(e,S):=S−{x/x∈S [symbol] x·c·t=e·t [symbol] x·c≠e}

−{x/x∈S [symbol] x·p≠null [symbol] x·p·t=e·t [symbol] x·p≠e}

−{x/x∈S [symbol] x·w≠null [symbol] x·w·t=e·t [symbol] x·w≠e}.

Intuitively, to represent a move and its relationship to other moves, a trievent (w, p, c) in R(t) declares current event c at step t with references to two previously declared events w and p. The state provider p provides the current state at step t. If p=null, then t=0, i.e. c=e₀ and w=null. The symbol writer w wrote the symbol currently being read at step t. If w=null, then initial input symbol X_{c h} is read at step t.

Define events declared in a trievent set S, E(S):={x·c/x∈S}.

An event (t, h, q, y, d) in E(R(t)), as an entity, represents that M enters next state q, writes symbol y in cell h, and then shifts the tape head from cell h to cell h+d at step t. Event e₀ initializes M. A t-computation is a sequence of (t+1) events, i.e. a deterministic computation of time complexity t, depending on M and its input X.

For an arbitrary subset P of R(0)∪ . . . ∪R(t), there are two kinds of redundant trievents by considering the relationship between a state provider declaration and its reference:
Trievents with state provider referenced but not declared:

orphans(P):={x/x∈P [symbol] x·p≠null [symbol] !∃_{y∈p}y·c=x·p};
Trievents, except at step t, with event declared but not referenced as a state provider:

barrens(P):={x/x∈P [symbol] x·c·t≠t [symbol] !∃_{y∈p}y·p=x·c}.

Let Δ(P):=P−orphans(P)−barrens(P) to delete redundant trievents.

Because P is a finite set, keeping deleting redundant trievents from P, sooner or later, Δ^{k+1}(P)=Δ^{k}(P) will be obtained, that is, neither orphan nor barren is left in Δ^{k}(P). Such a Δ^{k}(P) as the limit of P by Δ is denoted by lim_{Δ}(P).

For a subset S of R(0)∪ . . . ∪R(t) and a trievent m, to hypothesize m exclusively in t-computations in S, define

$$\begin{matrix}H ( m , S ) := S \text{-} \{ x / x ∈ S ⋀ x . c . t = m . c . t ⋀ x \neq m \} \\ \text{-} \{ x / x ∈ S ⋀ m . p \neq null ⋀ x . c . t = m . p . t ⋀ x . c \neq m . p \} \\ \text{-} \{ x / x ∈ S ⋀ m . w \neq null ⋀ x . c . t = m . w . t ⋀ x . c \neq m . w \} \\ \text{-} \{ x / x ∈ S ⋀ m . w \neq null ⋀ x . c . t > m . w . t ⋀ x . c . t < m . c . t ⋀ \\ x . c . h = m . w . h \} \\ \text{-} \{ x / x ∈ S ⋀ m . w = null ⋀ x . c . h = m . c . h ⋀ x . c . t < m . c . t \} .\end{matrix}$$

Define the third kind of redundant trievents

destructives(P):={x/x∈lim_{Δ}(P) [symbol] X∉lim_{Δ}(H/(x,lim_{Δ}(P)))}

and define

Ψ(P):=lim_{Δ}(P)−destructives(P).

Because P is a finite set, keeping deleting redundant trievents from P, sooner or later, Ψ^{k+1}(P)=Ψ^{k}(P) will be obtained, that is, neither orphan, nor barren, nor destructive is left. Such a Ψ^{k}(P) as the limit of P by Ψ is denoted by lim_{Ψ}(P).

It is proved by the present inventor that there is no t-computation in P if and only if lim_{Ψ}(P)=φ.

The third, the following is a list of the specific steps in the method of the provided exemplary aspect of the present invention, presented in the recommended order of processing, which calculates R(0), . . . , R((T(n)) iteratively and check if there is a final state in any of R(0), . . . , R((T(n)) respectively. If found, X is accepted by M, otherwise X is not accepted.

In an exemplary embodiment, the specific steps are listed as follows:

| | |
|---|---|
| [1] | For t:=0 until T(n) or infinite if T(n) is not available |

| | |
|---|---|
| [2] | If t=0 then R(t):={ (null, null, e₀) }; |
| [3] | Else |
| [4] | set R(t):=φ; |

| | |
|---|---|
| [5] | For each event eₜ₋₁∈ E(R(t−1)) |
| [6] | set P₀ := A(eₜ₋₁, R(0) ∪...∪ R(t−1)) to assume event |
| | eₜ₋₁ at step t−1; |
| [7] | set q := eₜ₋₁.q to be the next state; |
| [8] | set h := eₜ₋₁.h+eₜ₋₁.d to be the next tape head position; |
| [9] | set P₁ := P₀ − {x / x∈ P₀ [symbol] x.c.h=h} to further assume |
| | cell h has not been read; |

| | |
|---|---|
| [10] | If lim_{Ψ}(P₂) then |

| | |
|---|---|
| [11] | R(t) := R(t) ∪ {(null, eₜ₋₁, eₜ) / eₜ∈ |
| | T×H×Q×Y×D [symbol] eₜ.t=t [symbol] eₜ.h=h [symbol] |

(q, Xₕ, eₜ.q, eₜ.y, eₜ.d)∈ δ};

| | |
|---|---|
| [12] | For each selected event eₖ in E(P₀) with eₖ.h=h |

| | |
|---|---|
| [13] | P₂ := A(eₖ, P₀) − x / x∈ |
| | {P₀ [symbol] x.c.t>eₖ.t [symbol] x.c.h=h} to assume eₖ; |
| [14] | If lim_{Ψ}(P₂) then |

| | |
|---|---|
| [15] | R(t) := R(t) ∪ {( eₖ, eₜ₋₁, eₜ) / eₜ∈ |
| | T×H×Q×Y×D [symbol] eₜ.t=t [symbol] eₜ.h=h [symbol] |

(q, eₖ.y, eₜ.q, eₜ.y, eₜ.d)∈ δ};

| | |
|---|---|
| [17] | If there exist x∈ R(t) and x.c.q∈ Q_{f}, then return true |
| | indicating X is accepted by M; |

| | |
|---|---|
| [18] | Return false indicating X is not accepted. |

The fourth and the last, the following is a list of the specific steps in the method of the provided exemplary aspect of the present invention, presented in the recommended order of processing, which finds a specific t-computation in a subset P of R(0), . . . , R(t). If found, P is modified to contain one and exactly one t-computation for M on input X, otherwise P is modified to empty.

| | |
|---|---|
| [1] | For i:=0 to t |

| | |
|---|---|
| [2] | Let σᵢ(P) := {x / x∈ P [symbol] x.c.t=i}; |
| [3] | While \|σᵢ(P)\| > 1 |

| | |
|---|---|
| [4] | Select an arbitrary trievent m from P; |
| [5] | If lim_{Ψ}(P − σᵢ(P) + {m})=φ then |

| | |
|---|---|
| [6] | P := P−{m}; |

| | |
|---|---|
| [7] | Else |

| | |
|---|---|
| [8] | P := P − σᵢ(P) + {m}; |

With projection m·c for each trievent in P, a sequence of events is obtained.

### Advantageous Effects of Invention

The invention has, but not limited to, the following advantages over the existing devices or methods:
1. The invention is complete, error-free, and is more efficient in time complexity than existing methods. The method for simulating M on X is of time complexity O(T¹²(n)) log T(n). If T(n) is a polynomial of n, then the worst time complexity of the method is another polynomial of n.
2. The invention, especially the disclosed deterministic method for simulating a NDTM on input X, is easy to implement by use of existing experience, for example relation R can be implemented as a relational database table. The invention is economical to build in mass production in hardware and/or software and thus can optimize time and resources to save expenses. Without limiting, an existing general-purpose computer may be reused for the implementation of the present invention.
3. The invention can employ high performance CPU for parallel processing and can employ network for distributed processing for better performance.

### DESCRIPTION OF DRAWINGS

The following drawings are exemplary for illustrating the invention. However, the invention is not limited to the specific methods or instrumentalities disclosed. In the drawings:

FIG. 1 is a block diagram of an exemplary nondeterministic computing apparatus in which aspects of the present invention may be implemented.

FIG. 2 is a block diagram of the nondeterministic computing components according to one embodiment of the invention.

FIG. 3 is a flow diagram of the steps of the disclosed method for simulating a NDTM M on input X according to one embodiment of the invention.

FIG. 4 is a flow diagram of the steps of the disclosed method for finding a t-computation in P for a NDTM M on input X according to one embodiment of the invention.

### MODE FOR INVENTION

Exemplary Nondeterministic Computing Apparatus

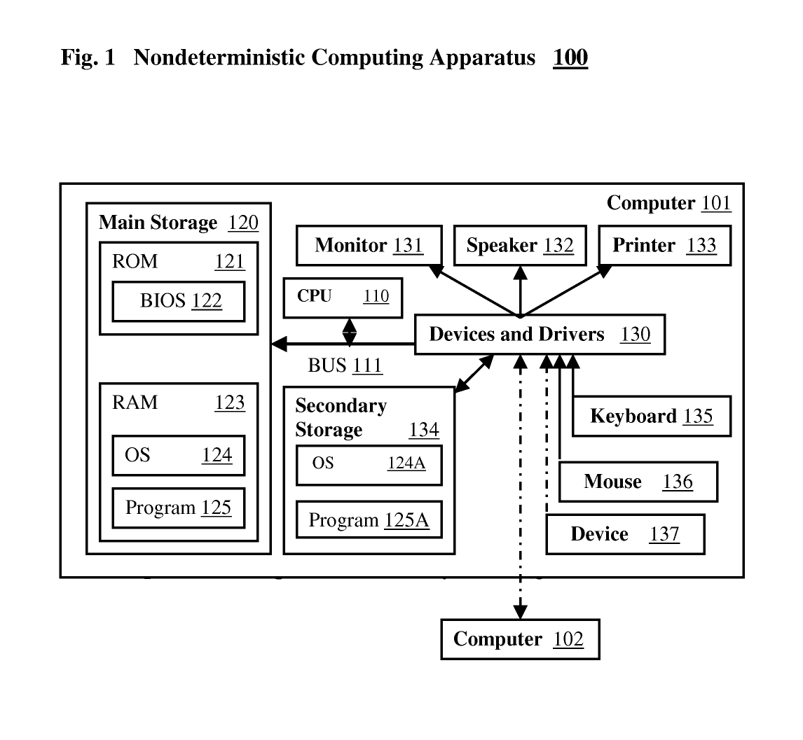

FIG. 1 shows an exemplary nondeterministic computing apparatus 100, which consists of a computer 101 and/or 102 as a deterministic computing apparatus and aspects of the invention implemented. The nondeterministic computing apparatus 100 is only an example of suitable nondeterministic computing apparatus and it is not intend to suggest any limitation as to any aspect of the invention. The invention may be implemented by use of, but not limited to, an electronic computer, an optical computer, a DNA computer, or a quantum computer, or a combination of them.

The invention may be implemented in general context as software, such as in, but not limited to, shared library form or executable form. The invention may be implemented in general context as hardware, such as, but not limited to, a circuit or a device with a driver (for example device 137). The invention may be implemented as a combination of software and hardware to fulfill the functionality of the invention. The invention may be implemented in parallel or over a network where the functionality of the invention is distributed across two or more CPU's, such as in computer 101 and computer 102.

With reference to FIG. 1, an exemplary nondeterministic computing apparatus 100 is illustrated. In it, computer 101 and 102 are composed of CPU 110, main storage 120, optional devices and drivers 130, and bus 111 which connecting them together, but not limited to, as shown. Devices and Drivers 130 further are optionally composed of a monitor 131, a speaker 132, a printer 133, a secondary storage 134, a keyboard 135, a mouse 136; and, one or more other device 137 (for example a digital camera) and one or more other computer 102, connected by, but not limited to, network interface or direct link. The main storage includes nonvolatile ROM 121 and volatile RAM 123. In addition to BIOS 122, an embodiment of the invention may be stored inside ROM 121 and RAM 123. The nonvolatile secondary storage 134 further includes, but not limited to, OS 124A and one or more program 125A, which may include an embodiment of the invention, as a part or a whole of the present invention. Loaded OS 124 is either a part or the whole of OS 124A. Loaded program 125 is either a part or the whole of program 125A.

Nondeterministic Computing Component

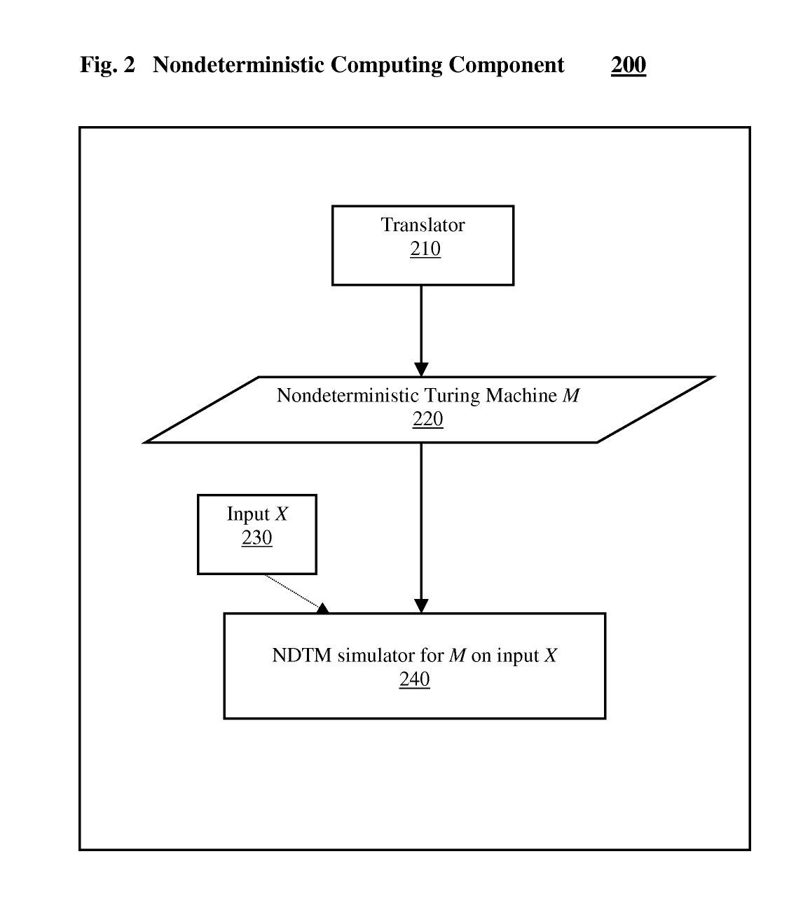

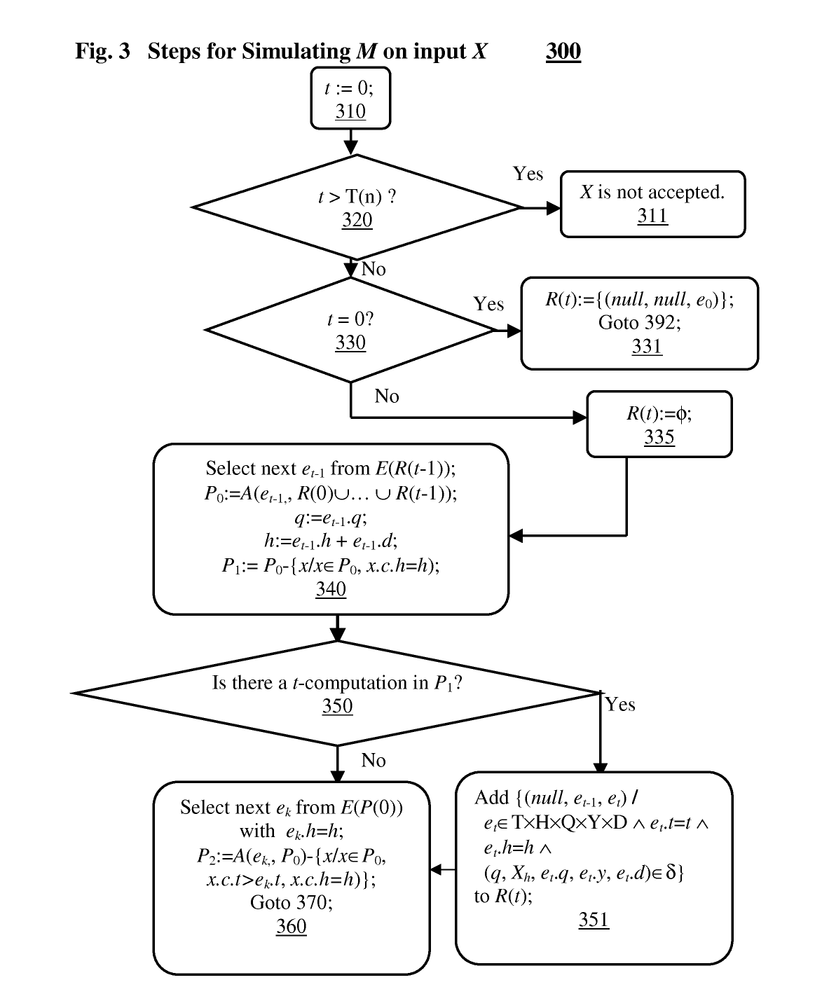

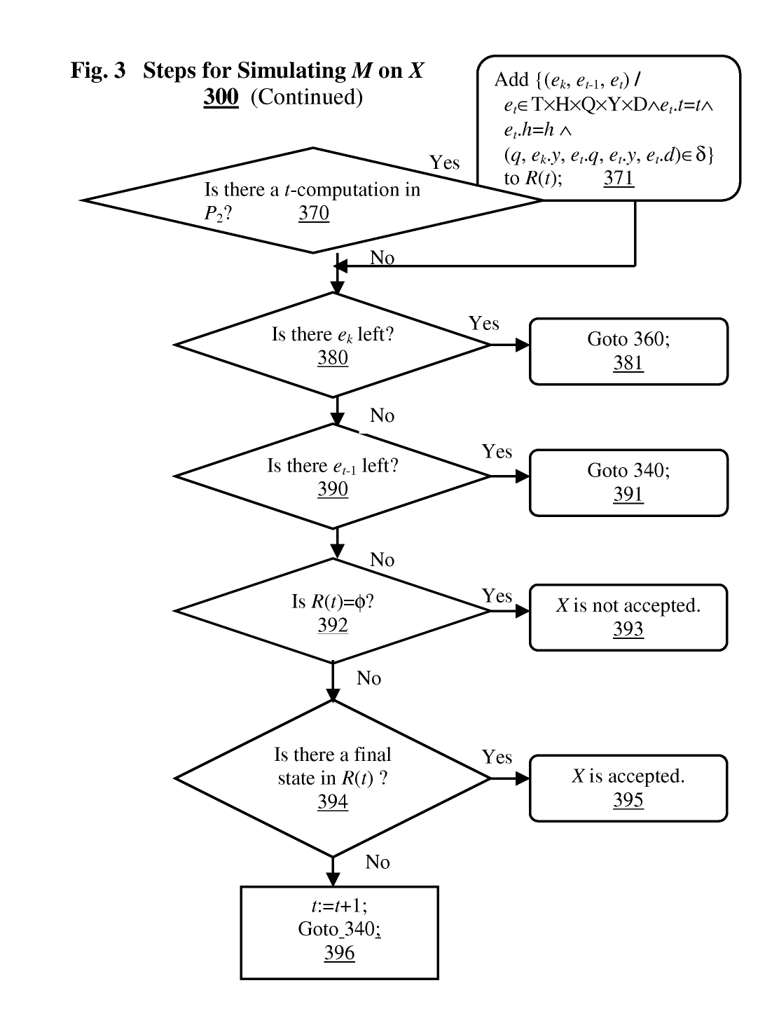

With reference to FIG. 2, according to one embodiment of the invention, nondeterministic computing component 200 composing:
One or more translator 210 translating other nondeterministic Turing machines or equivalent nondeterministic computation representations into the format of the nondeterministic Turing machine 220;
An input 230 to the nondeterministic Turing machine 220;
A NDTM 220 in the format in the present invention;
A NDTM simulator 240 for NDTM 220 and its input 230. The NDTM simulator 240 simulates NDTM 220 on its input 230 in the disclosed method. The NDTM simulator 240 is fulfilled by 300 in details with reference made to FIG. 3.

Steps for Simulating M on Input X

With reference made to FIG. 3, according to one embodiment of the present invention, the disclosed method for simulating NDTM M with time complexity T(n) on input X of length n is composed of the following steps:
310. Initialize the step counter t to 0.
320. If t>T(n), then in 311 input X is not accepted by M; otherwise
330. If t=0, then 331 set R(t) to {(null, null, e₀)} and then goto 329, where e₀:=(0, −1, q₀, b, +1) in T×H×Q×Y×D and null is a place holder for the absence of an event as disclosed in present invention; otherwise
335. Initialize R(t) to the empty set φ.
340. Select next E_{T-1} from E(R(t−1)), initialize P₀ to A(eₜ₋₁, R(0)∪ . . . ∪R(t−1)), initialize q to eₜ₋₁·q, initialize h to eₜ₋₁·h+eₜ₋₁·d, initialize P₁ to P₀−{x/x∈P₀, x·c·h=h)}.
350. If there is a t-computation in P₁, then go to step 351; otherwise go to step 360.
   In one embodiment of the present invention, lim_{Δ}(P₁)≠φ is applied to check whether there is a t-computation in P₁, where lim_{Δ}(P₁) is disclosed in the present invention. In another embodiment of the present invention, a logically equivalent of lim_{Δ}(P₁) may be applied to check whether there is a t-computation in P₁ with references to R(0), . . . , R(t−1), M, X and user's domain knowledge for better performance.
351. Add {(null, eₜ₋₁, eₜ)/eₜ∈T×H×Q×Y×D [symbol] eₜ·t=t [symbol] eₜ·h=h [symbol] (q, Xₕ, eₜ·q, eₜ·y, eₜ·d)∈δ} to R(t).
360. Select next eₖ from E(P₀) with eₖ·h=h, initialize P₂ to A(eₖ, P₀)−{x/x∈P₀, x·c·t>eₖ·t, x·c·h=h)}.
   In one embodiment of the present invention, each eₖ is selected in some predefined order as disclosed in the present invention.
   In another embodiment of the present invention, each eₖ may be select with references to R(0), . . . , R(t−1), M, X, eₜ, t, and user's domain knowledge to skip some eₖ's from E(P₀) with eₖ·h=h for better performance.
370. If there is a t-computation in P₂, then go to step 371; otherwise go to step 380.
   In one embodiment of the present invention, lim_{Δ}(P₂)≠φ is applied to check whether there is a t-computation in P₂, where lim_{Δ}(P₂) is disclosed in the present invention.
   In another embodiment of the present invention, a logically equivalent of lim_{Δ}(P₂) may be applied to check whether there is a t-computation in P₂ with references to R(0), . . . , R(t−1), M, X, eₜ, t, and user's domain knowledge for better performance.
371. Add {(eₖ, eₜ₋₁, eₜ)/eₜ∈T×H×Q×Y×D [symbol] eₜ·t=t [symbol] eₜ·h=h [symbol] (q, eₖ·y, eₜ·q, eₜ·y, eₜ·d)∈δ} to R(t).
   380. If there eₖ left, then (in 381) goto 360 to process next eₖ, otherwise
   390. If there eₜ₋₁ left, then (in 340) goto 340 to process next eₜ₋₁, otherwise
   392. If R(t)=4, then (in 393) input X is not accepted because no further move, otherwise
   394. If there a final state in R(t), then (in 395) input X is accepted, otherwise
   396. Add 1 to t and then goto 340 to process next step.

Steps for Finding a t-Computation in P for M on X

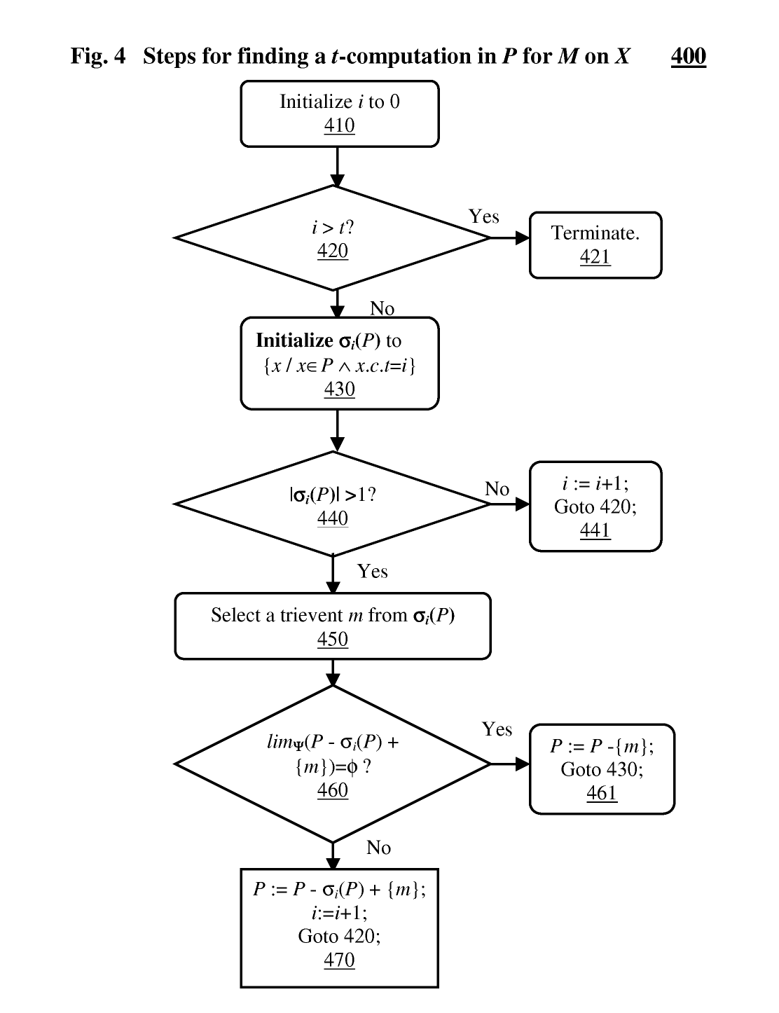

With reference made to FIG. 4, according to one embodiment of the present invention, a method is disclosed for finding a t-computation in a subset P of R(0), . . . , R(t). If found, P is modified to contain one and exactly one t-computation as the result for M on input X, otherwise P is modified to empty to indicate no t-computation exists in P. The method is composed of the following steps:
410. Initialize the step counter i to 0;
420. If i is greater than t, goto 421 and terminate, otherwise
430. Initialize σᵢ(P) to {x/x∈P [symbol] x·c·t=i};
440. if |σᵢ(P)|>1, then goto 441, otherwise
450. Select an arbitrary trievent m from P or select m from P based on user's preference;
460. If lim_{Ψ}(P−σᵢ(P)+{m})=φ, then goto 461, otherwise
470. P:=P−σᵢ(P)+{m}; i:=i+1; goto 420;
441. i:=i+1; goto 420;
461. P:=P−{m}; goto 430.

### CITATION LIST

### US Patents Referenced (with Keywords in Bold for Easy Patent Search)

| Number | Inventor | Year | Title |
|---|---|---|---|
| 6,463,422 | Hangartner | 2002 | Probabilistic computing methods and apparatus |
| 7,400,282 | Tanaka, et al. | 2008 | Quantum Turing machine |
| 7,130,093 | Dolev, et al. | 2006 | Optical implementation of bounded non- |
| | | | deterministic Turing Machines |
| 5,843,661 | Rothemund | 1998 | Method for construction universal DNA based |
| | | | molecular Turing machine |
| 6,266,569 | Shapiro, et al. | 2001 | Method and system of computing similar to a |
| | | | Turing machine |
| 7,577,625 | Zhang | 2009 | Handling of satisfaction and conflicts in a |
| | | | quantified Boolean formula solver |
| 7,992,113 | Goldberg | 2011 | Methods and apparatus for decision making in |
| | | | resolution based SAT solvers |
| 7,860,814 | Plotnick | 2010 | System and method for providing a user-selected |
| | | | best solution to an NP-complete scheduling problem |
| 5,678,055 | Noro | 1997 | Method and device for generating Grobner bases to |
| | | | reduce memory usage and increase computing speed |
| 8,577,825 | Clayton | 2013 | System, Method and Device for Solving Problems in |
| B2 | Gilespie | | NP without Hyper-polynomial Cost |

### Other References

Aho, A. V., Hoperoft J. E. and Ullman J. D. 1974. The Design and Analysis of Computer Algorithms, Addison-Wesley.
Codd, E. F. 1970. “A Relational Model of Data for Large Shared Data Banks”. CACM 13 (6): 377-387.
Cook, S. A. 1971. “The Complexity of Theorem Proving Procedures”. STOC 1971, 151-158.
Cox, D., J. Little and D. O'shea. 2007. IDEAS, VARIETIES, AND ALGORITHMS—An Introduction to Computational Algebraic Geometry and Commutative Algebra, Springer
Fortnow, L. 2009. “The Status of The P versus NP Problem”. CACM, Vol. 52, No. 9, 78-86.

1. A nondeterministic computing apparatus, composing:
One or more computers, and
One or more nondeterministic computing components.

2. The said nondeterministic computing component of claim [1], composing:
Zero, one or more translators to transform other equivalent nondeterministic computations into the format of a nondeterministic Turing machine (NDTM) M as disclosed in the present invention, and/or
A nondeterministic Turing machine (NDTM) M, in the format, but not limited to, as disclosed in the present invention, and
An input X to M, in the format, but not limited to, as disclosed in the present invention, and
A NDTM simulator for M on input X, as disclosed in one embodiment of the present invention, or its equivalent transformation into any of other nondeterministic Turing machines or any of other equivalents in different grammar and/or in different encoding.

3. A relational model and their equivalents for nondeterministic Turing machine M on an input X, composing:
Events, as entities, each in the format, but not limited to, (t, h, q, y, d) representing the instantaneous changes that M enters next state q, writes symbol y in cell h, and then shifts the tape head from cell h to cell h+d at step t, where d is −1 or +1 for directions left and right, respectively, as disclosed in one embodiment of the present invention, and
Trievents, as a relation, each in the format of, but not limited to, (w, p, c) representing both a move of M and its relationships to other moves by three events w, p, and c such that (p·q, w·t, c·q, c·y, c·d) is in the transition relation of M, as disclosed in one embodiment of the present invention, and
A deterministic computation of time complexity t (or t-computation) of M on X represented in the format of a sequence of t+1 events or t+1 trievents, as disclosed in one embodiment of the present invention, and
All the deterministic computations of time complexity t (or all t-computations) of M on X represented as a set of trievents, as disclosed in one embodiment of the present invention.

4. Any demoralized model of the said relational model in claim [3] including, but not limited to, using or interpreting t as a computer clock click count, and/or using or interpreting h as a computer memory location and/or storage location.

5. A method to determine whether nondeterministic Turing machine M accepts its input X, composing:
An assumption of an event in a set of trievents by deleting trievents, as disclosed in one embodiment of the present invention and
A hypothesis of a trievent in a set of trievents by deleting trievents, as disclosed in one embodiment of the present invention, and
One or more of the said assumptions and/or one or more of the said hypotheses in one or more combinations in any order in the calculation of trievents of M on X, as disclosed in one embodiment of the present invention, and
The use of a necessary and sufficient condition lim_{Ψ}(P)=φ or its equivalents to check whether there is a t-computation in an arbitrary set P of trievents after zero or one or more assumptions, or after zero or one or more hypotheses, or after their combinations in any order, as disclosed in one embodiment of the present invention.

6. A method for finding a specific event sequence, or a specific t-computation, or their equivalents, in a subset P of R(0)∪ . . . ∪R(t) or its equivalent, for a nondeterministic Turing machine M on input X as disclosed in one embodiment of the present invention.
